(19) United States
(12) Patent Application Publication
(10) Pub. No.: US 2024/0270577 A1
(43) Pub. Date: Aug. 15, 2024

(54) METHODS OF PRODUCING CATHODE MATERIAL PRECURSORS

(71) Applicant: Tesla, Inc., Austin, TX (US)

(72) Inventors: Alex Carpenter, Seabrook, TX (US); Turner Boris Caldwell, San Francisco, CA (US)

(21) Appl. No.: 18/565,492

(22) PCT Filed: May 31, 2022
(86) PCT No.: PCT/US2022/031605

§ 371 Date: Nov. 29, 2023

Related U.S. Application Data
(60) Provisional application No. 63/195,545, filed on Jun. 1, 2021.

(51) Int. Cl. C01B 25/45; C01B 25/37; C01G 53/00; C01G 53/04; H01M 4/58

(52) U.S. Cl. CPC C01B 25/45; C01B 25/375; C01G 53/04; C01G 53/42; C01G 53/44; C01P 2006/40; H01M 4/5825

(57) ABSTRACT

Methods of producing cathode material precursors from metal carbonyl complexes are described.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference under 37 CFR 1.57, and Rules 4.18 and 20.6, such as U.S. Provisional App. No. 63/195,545, filed Jun. 1, 2021.

### BACKGROUND

Lithium ion batteries are desirable for their optimized cost, safety, lifespan and moderate energy density. Current methods of cathode manufacturing employ a large number of steps and can produce substantial quantities of waste products. For example, some conventional cathode material manufacturing processes (e.g. lithium iron phosphate) require nano particles to be manufactured, which require spray drying or multiple chemical steps. Thus, new methods that reduce or eliminate processing steps in the manufacturing of battery raw materials may aid to decrease the end-use cost of lithium-ion batteries.

### SUMMARY

For purposes of summarizing the disclosure and the advantages achieved over the prior art, certain objects and advantages of the disclosure are described herein. Not all such objects or advantages may be achieved in any particular embodiment. Thus, for example, those skilled in the art will recognize that the invention may be embodied or carried out in a manner that achieves or optimizes one advantage or group of advantages as taught herein without necessarily achieving other objects or advantages as may be taught or suggested herein.

All of these embodiments are intended to be within the scope of the invention herein disclosed. These and other embodiments will become readily apparent to those skilled in the art from the following detailed description of the preferred embodiments having reference to the attached figures, the invention not being limited to any particular preferred embodiment(s) disclosed.

In one aspect, a method of producing a cathode material precursor is described. The method includes: reacting a metal carbonyl complex with an acid to form a cathode material precursor.

In some embodiments, the metal carbonyl complex may include a metal selected from Ni, Co, Fe, Mn, and combinations thereof. In some embodiments, the metal carbonyl complex may include Ni(CO)₄, Co(CO)₃(NO), H₂Fe(CO)₄, HCo(CO)₄, Co₂(CO)₈, Fe(CO)₅, Mn₂(CO)₁₀, Li[HFe(CO)₄], a metal carbonyl isocyanide complex thereof, a metal carbonyl phosphine complex thereof, and combinations thereof. In some embodiments, the acid may include H₃PO₄, H₃PO₃, H₂SO₄, H₂SO₃, HNO₃, HNO₂, HI, HBr, HCl, HF, and combinations thereof. In some embodiments, the metal carbonyl complex may be heated to about 30 to 150° C. In some embodiments, the method of producing a cathode material precursor further includes isolating the cathode material precursor. In some embodiments, the method of producing a cathode material precursor further includes reacting the cathode material precursor with a lithium salt compound to form a cathode active material. In some embodiments, the lithium salt compound may include at least one of LiOH and LiCO₃. In some embodiments, an iron ore comprises the metal carbonyl complex. In some embodiments, the iron ore may be reacted with the acid to form the cathode material precursor. In some embodiments, the cathode material precursor may include a metal hydroxide, a metal oxide, a metal nitrate, a metal sulfate, or a metal phosphate.

In another aspect, a method of producing a cathode material precursor is described. The method includes: heating a metal carbonyl complex to form a metal powder; and reacting the metal powder with an acid to form a cathode material precursor.

In some embodiments, the metal carbonyl complex is heated at a temperature between 25-200° C. In some embodiments, reacting a metal carbonyl complex with an acid decomposes the metal carbonyl complex into fine particle sized metal powders. In some embodiments, the fine particle sized metal powders are nano-sized. In some embodiments, the fine particle sized metal powders range from about 0.1 μm to about 50 μm. In some embodiments, one or more steps are performed in a gaseous phase.

In another aspect, a method of producing a cathode active material is described. The method includes: reacting a metal carbonyl complex with lithium hydroxide to form a lithium hydride metal carbonyl; and reacting the lithium hydride metal carbonyl with an acid to form a cathode active material.

In some embodiments, the method of producing a cathode active material further includes calcinating the lithium metal hydride in the presence of an oxidant.

In another aspect, a method of producing a cathode active material is described. The method includes: reacting a first metal carbonyl complex with a base to form a metal hydroxide.

In some embodiments, the method of producing a cathode active material further includes reacting the first metal carbonyl complex with a second metal carbonyl complex, wherein the second metal carbonyl complex may be Ni(CO)₄, Co(CO)₃(NO), H₂Fe(CO)₄, HCo(CO)₄, Co₂(CO)s, Fe(CO)₅, Mn₂(CO)₁₀, Li[HFe(CO)₄], a metal carbonyl isocyanide complex thereof, a metal carbonyl phosphine complex thereof, and combinations thereof. In some embodiments, the first metal carbonyl complex is exposed to ultraviolet light. In some embodiments, the first metal carbonyl complex is exposed to manganese sulfate, sodium aluminate, or combinations thereof.

In another aspect, a method of producing a cathode material precursor is described. The method includes: mixing a first gaseous stream comprising an inert carrier gas and a metal carbonyl complex with a second gaseous stream comprising an oxidant; and heating the mixed first and second gaseous streams to form a cathode material precursor.

### DETAILED DESCRIPTION

The methods of the present disclosure provide a direct route to cathode production by eliminating the need for metal powders or metal sulfates during the manufacturing process. The methods of the present disclosure may include reacting metal carbonyl complexes to produce cathode material precursors and cathode materials for use in energy storage devices. In some embodiments, the methods of the present disclosure may include acid methods, base methods, hydride methods, or oxidant methods, or combinations thereof. For example, in some embodiments, producing a cathode material precursor and/or cathode material can be performed by the acid method in combination with the hydride method. In other embodiments, producing a cathode material precursor and/or cathode material can be performed by the base method in combination with the oxidant method.

### Metal Carbonyl Complexes

Metal carbonyl complexes are a large class of low-valent, low-coordinate transition metal compounds. They are unique because they function as molecular sources of reduced metals and are characterized by their propensity to undergo redox reactions with small molecules to afford oxidized metal species and reduced products. Classical examples of metal carbonyls are Ni(CO)₄, Co₂(CO)₈, and Fe(CO)₅. Metal carbonyls are generated in large scales and are readily available at low costs. Metal carbonyls may be used in catalysis, the and the production of high purity metal powders. For example, many carbonyls (e.g. nickel and iron carbonyls) are known intermediates in vapor metallurgical refining (e.g. Mond process). The Mond process is widely utilized to refine nickel and iron from sulfide deposits, laterite deposits or other material sources. While industry has typically treated these carbonyl intermediates as intermediates to be decomposed to afford high purity metal powders or pellets, the present disclosure achieves direct use of the carbonyl intermediates to produce high value cathode active materials and/or intermediates.

In some embodiments, a metal of the metal carbonyl complex may include Ni, Co, Fe, Mn, or combinations thereof. In some embodiments, metal carbonyl complexes may include binary metal carbonyls, (e.g. such as Ni(CO)₄, Co₂(CO)s, Fe(CO)₅, and Mn₂(CO)₁₀), metal carbonyl hydrides, (e.g. such as H₂Fe(CO)₄ and HCo(CO)₄), metal carbonyl nitrosyls, (e.g. such as Co(CO)₃(NO)), metal carbonyl hydride salts (e.g. such as lithium hydride metal carbonyls (Li[HFe(CO)₄])), other metal carbonyl complexes containing alternative ligands (e.g. such as isocyanides and phosphines), and combinations thereof.

In some embodiments, iron ore comprises the metal carbonyl complex. In some embodiments, the iron ore may be utilized in the methods disclosed herein, whereby the metal carbonyl complex is reacted to produce the cathode material precursor (e.g., without purifying the iron ore and/or extracting the metal carbonyl complex from the iron ore). In some embodiments, the iron ore may be reacted by the acid method, the base method, the hydride method, the oxidant method, or by a combination method thereof.

### Cathode Material Precursors and Cathode Materials

In some embodiments, the cathode material precursor may include metal hydroxides (NiₓCo_{y}Mn_{z}Alₐ(OH)₂; x+y+z+a=1), metal oxides (LiNiₓCo_{y}Mn_{z}Alₐ(O)₂), metal nitrates, metal sulfates, or metal phosphates. In some embodiments, the cathode active material may include a metal oxide, metal sulfide, lithium metal oxides and/or phosphates, such as for example lithium nickel-manganese-cobalt oxide (NMC), nickel-manganese-aluminum oxide (NMA), lithium iron phosphate (LFP), lithium nickel manganese spinel (LNMO), lithium nickel cobalt aluminum oxide (NCA), lithium manganese oxide (LMO), and lithium cobalt oxide (LCO). In some embodiments, cathode active materials can comprise, for example, a layered transition metal oxide (such as LiCoO₂ (LCO), Li(NiMnCo)O₂ (NMC) and/or LiNi_{0.8}Co_{0.15}Al_{0.05}O₂ (NCA)), a spinel manganese oxide (such as LiMn₂O₄ (LMO) and/or LiMn_{1.5}Ni_{0.5}O₄ (LMNO)), an olivine (such as LiFePO₄ (LFP) or LiMn₁₋ₓFeₓPO₄ (LMFP)).

### Methods of Preparing Cathode Material Precursors and Cathode Materials

In some embodiments, one or more steps may be performed in a gaseous phase. In other embodiments, one or more steps the methods of the present disclosure may be performed in an aqueous phase.

In some embodiments, producing a cathode material precursor may include a direct oxidation of metal carbonyl complexes. In some embodiments, producing a cathode material precursor may include reacting a metal carbonyl complex (e.g. metal carbonyl) with an acid, a base, a lithium salt, an oxidant, or combinations thereof.

In some embodiments, producing a cathode material precursor and/or cathode material can be performed using heat and/or light. In some embodiments, producing a cathode material precursor and/or cathode material can be performed at, at about, at least, or at least about, 25° C., 30° C., 40° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 300° C., 350° C., 400° C., 450° C. or 500° C., or any range of values therebetween. In some embodiments, producing a cathode material precursor and/or cathode active material can be performed in the presence of low, moderate, or high intensity light, or combinations thereof. In some embodiments, the metal carbonyl complex may be exposed to ultraviolet light. In some embodiments the light is short wavelength visible light, long wavelength UV light, medium wavelength UV light or short wavelength UV light, or combinations thereof. In some embodiments, the metal carbonyl complex may be simultaneously and/or sequentially heated and exposed to ultraviolet light, or vice versa.

In some embodiments, the cathode material precursor may be isolated from the reaction mixture. In some embodiments, the cathode material may be isolated from the reaction mixture. In some embodiments, isolation may include filtration, crystallization, and combinations thereof.

In some embodiments, a cathode material precursor can be reacted with a lithium salt to produce a cathode material or cathode active material. For example, in some embodiments, a lithium salt may be selected from LiOH, LiCO₃, hydrates thereof, and combinations thereof.

In some embodiments, metal carbonyls can be reacted to form fine particle sized metal powders. In some embodiments, the fine particle sized metal powders are nano-sized. In some embodiments, metal carbonyls can react to form fine particle sized metal powders of, of about, of at most, or of most about, 0.1 μm, 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 25 μm, 30 μm, 35 μm, 40 μm, 45 μm, 50 μm, 55 μm, 60 μm, 65 μm, 70 μm, 75 μm, 80 μm, 85 μm, 90 μm, 95 μm or 100 μm, or any range of values therebetween. In some embodiments, the fine particle sized metal powder sizes are an average particle size or a particle size distribution (e.g. D₅₀ particle size distribution).

In some embodiments, producing a cathode material precursor and/or cathode active material can be performed in the presence of an additive. In some embodiments, an additive may function as an oxidant and/or a stabilizer. In some embodiments, for example, the additives may include Lewis bases, surfactants, chelates, manganese sulfate, sodium aluminate, or oxygen atom transfer reagents (e.g. oxidants), or combinations thereof.

### Acid Method

In some of the methods disclosed herein, producing a cathode material precursor and/or cathode material can be performed by reacting the metal carbonyl complex, or an intermediate thereof, with an acid. In some embodiments, an acid may include a strong acid and/or a weak acid. In some embodiments, an acid may be selected from H₃PO₄, H₃PO₃, H₂SO₄, H₂SO₃, HNO₃, HNO₂, HI, HBr, HCl, HF, or combinations thereof.

In some embodiments, the methods of producing a cathode material precursor may include an in situ dissolution of metal powder. In some embodiments, the methods of producing a cathode material precursor may include heating a metal carbonyl complex to form a metal powder, and reacting the metal powder with an acid. In some embodiments, the method is conducted in the presence of an oxidant (e.g., oxygen) and/or elevated temperature.

In some embodiments, a cathode for a lithium ion battery is produced by reacting iron pentacarbonyl with an acid such as H₃PO₄ to form an iron(III) phosphate precursor. The precursor is then contacted with a lithium salt compound (e.g. such as LiOH and/or LiCO₃) to form a lithium iron(III) phosphate cathode material.

### Base Method

In some of the methods disclosed herein, producing a cathode material precursor and/or cathode material can be performed by reacting the metal carbonyl complex, or an intermediate thereof, with a base. In some embodiments, a base may include a strong base and/or a weak base. In some embodiments, producing a cathode material precursor and/or cathode active material can be performed in the presence of aqua ammonia or an alternative Lewis base. In some embodiments, a Lewis base may include aqua ammonia, NaOH, LiOH, CaOH₂, MgOH₂, triethylamine, pyridine, or combinations thereof.

In other embodiments, producing a cathode material precursor and/or cathode active material can be performed in the presence of a second metal carbonyl complex. For example, in some embodiments, the second metal carbonyl complex may include Ni(CO)₄, Co(CO)₃(NO), H₂Fe(CO)₄, HCo(CO)₄, Co₂(CO)s, Fe(CO)₅, Mn₂(CO)₁₀, or combinations thereof.

### Hydride Method

In some of the methods disclosed herein, producing a cathode material precursor and/or cathode material can be performed through the formation of a hydride. In some embodiments, the methods of producing a cathode material precursor and/or cathode material may include reacting the metal carbonyl complex to form a metal carbonyl hydride salts (e.g. such as lithium hydride metal carbonyls (Li[HFe(CO)₄])). In some embodiments, the methods of producing a cathode material precursor and/or cathode material may include reacting a metal carbonyl complex with a lithium salt (e.g., lithium hydroxide) to form a lithium hydride metal carbonyl (i.e., cathode material precursor). In some embodiments, the lithium hydride metal carbonyl is further reacted with an acid to form the cathode material.

In some embodiments, a metal carbonyl complex is vapor-phase deposited onto lithium salt (e.g., LiOH·H₂O) particles to form a metal coated lithium salt (i.e., cathode material precursor). In some embodiments, the metal coated lithium salt is calcinated to form the cathode material. In some embodiments, calcination is performed in the presence of an oxidant. In some embodiments, the oxidant may include a gas comprising oxygen (e.g., oxygen gas, an oxygen rich gas, or normal atmosphere), an oxidizing agent, or combinations thereof.

### Oxidant Method

In some embodiments, producing a cathode material precursor may include reacting the metal carbonyl complex, or an intermediate thereof, with an oxidant. In some embodiments, producing a cathode material precursor and/or cathode active material can be performed in the presence of one or more oxidants. In some embodiments, the metal carbonyl complex is mixed with an oxidant. In some embodiment, the metal carbonyl complex is in gaseous form. In some embodiments, a first gaseous stream comprises the metal carbonyl complex and a carrier gas. In some embodiments, the carrier gas is an inert gas (e.g., nitrogen, carbon dioxide, helium, neon, argon, krypton, xenon). In some embodiments, a second gaseous stream comprises the oxidant. In some embodiments, the first and second gaseous streams are mixed and/or reacted. In some embodiments, an oxidant may include O₂, O₃, N₂O, NO₂, N₂O₄, HNO₃, KNO₃, NH₄NO₃, H₂O₂, H₂SO₄, NaClO, KMnO₄, PbO₂, or combinations thereof. In some embodiments, the oxidants may be a gas, a liquid, or a combination thereof. In some embodiments, reaction of the metal carbonyl complex with an oxidant may be performed in the presence of heat and/or light.

### Combination of Methods

In some of the methods disclosed herein, two or more of the aforementioned methods may be combined. For example, in some embodiments, producing a cathode material precursor and/or cathode material can be performed by the acid method in combination with the hydride method. In other embodiments, producing a cathode material precursor and/or cathode material can be performed by the base method in combination with the oxidant method.

### Energy Storage Device

Once a cathode active material is prepared, the cathode active material may be utilized in an electrode for an energy storage device. In some embodiments, an electrode film comprises the cathode active material described herein. In some embodiments, the cathode active material is incorporated into an electrode film. In some embodiments, the electrode film further comprises a binder. In some embodiments, an electrode comprises a current collector and the electrode film described herein. In some embodiments, the electrode film is disposed over a current collector to form a cathode electrode.

In some embodiments, an energy storage device utilizes the cathode active material described herein. In some embodiments, the energy storage device comprises a separator, an anode electrode, the cathode electrode described herein, and a housing, wherein the separator, anode electrode and cathode electrode are disposed within the housing and the separator is positioned between the anode and cathode electrodes. In some embodiments, an energy storage device is formed by placing a separator, an anode electrode and the cathode electrode described herein within a housing, wherein the separator is placed between the anode electrode and the cathode electrode. In some embodiments the energy storage device is a battery. In some embodiments the energy storage device is a lithium ion battery.

### EXAMPLES

Cathode material precursors and cathode active materials of the present disclosure may be prepared utilizing the methods disclosed herein.

### Example 1

A cathode material precursor is prepared by direct oxidation as shown in Scheme 1. Under an inert atmosphere, water (e.g., deoxygenated and/or deionized water) is added to a pressure vessel (e.g., round-bottom flask) equipped with an agitator (e.g., magnetic stir bar). The vessel is then heated to a desired temperature (e.g. 30-150° C.). Iron pentacarbonyl is then added, drop wise, by syringe over the course of 5 minutes with aggressive stirring to ensure effective dispersion of the resulting biphasic mixture. Phosphoric acid (65-85%) is then introduced, via syringe or other suitable transfer device. Via air-stone or other suitable gas dispersion apparatus, the liquid phase is gradually oxygenated. This results in H₂/CO/CO₂ evolution and concomitant formation (e.g., precipitation) of iron(III) phosphate. The agitation rate, temperature and the reagent addition rate are used to control product morphology. Once gas evolution ceases, the reaction mixture is cooled to room temperature and the product isolated by filtration.

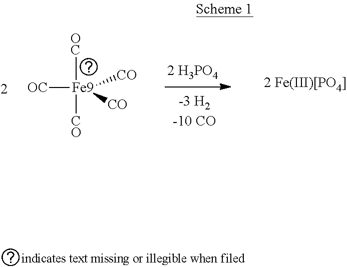

### Examples 2 and 3

A cathode material precursor is prepared by a two-step oxidation as shown in Scheme 2. Iron pentacarbonyl is introduced into a distillation flask along with magnetic stir bar. The flask is heated to produce Fe(CO)₅ vapor which is brought through a heated glass tube by means of nitrogen carrier gas. The tube is heated to a temperature sufficient to induce rapid decomposition of iron pentacarbonyl into nano-sized iron powder. The iron metal is allowed to fall into a stirred flask of dilute phosphoric acid. As iron metal enters the phosphoric acid solution, it is converted to iron(III) phosphate with concomitant evolution of H₂. The iron(III) phosphate is then filtered and dried.

In addition, a cathode material precursor is prepared by an in situ two-step decomposition/oxidation also shown in Scheme 2. Using a nitrogen as a carrier gas, iron pentacarbonyl vapor (15-40 v/v %) is introduced into the headspace of a stirred pressure vessel (e.g., distillation flask) containing phosphoric acid (65-85%) and water. The vessel is sealed and heated to induce thermolysis of Fe(CO)₅. As the Fe(CO)₅ is decomposed, iron metal forms in situ and is allowed to react with H₃PO₄ to afford iron(III) phosphate.

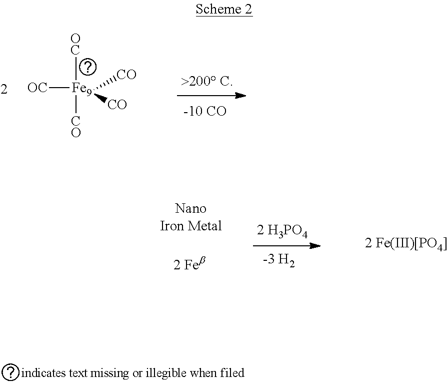

### Example 4

A cathode material is prepared as shown in Scheme 3. Iron pentacarbonyl is introduced, via syringe, to a stirred aqueous solution of lithium hydroxide to form lithium iron tetracarbonyl hydride. The stir rate, temperature, and rate of Fe(CO)₅ addition can be used to control intermediate particle size and morphology. Once the Fe(CO)₅ is completely consumed, the aqueous solution is quenched with phosphoric acid to form lithium iron phosphate whereupon stir rate, and the rate of phosphoric acid addition are again used to control product morphology. The lithium iron phosphate is isolated by filtration.

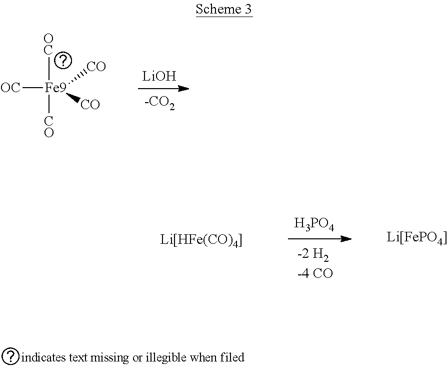

### Example 5

A cathode material precursor (e.g., nickel hydroxide) is prepared by direct oxidation as shown in Scheme 4. In a batch, semi-batch or continuous pressure reactor, an oxygen-free suspension of nickel tetracarbonyl (Ni(CO)₄) in water is gently heated (e.g. 0-150° C.) and/or exposed to ultraviolet light. This system is mixed aggressively so as to ensure effective dispersion of the biphasic mixture. This is performed in the presence of aqua ammonia or an alternative Lewis base. The pH of the reaction mixture is optionally controlled by varying the concentration of ammonia or other hydroxide sources (e.g. NaOH, LiOH, CaOH₂, MgOH₂). One or more oxidants are gradually introduced into the reactor either as gases (e.g. O₂, N₂O), salts (e.g. NH₄NO₃) or solutions. Under these conditions, CO molecules dissociate to afford low-coordinate, nickel carbonyls (e.g. Ni(CO)₃, Ni(CO)₂ or Ni(CO)) and/or submicron nickel powders. These intermediates undergo redox reactions with the oxidant and/or water to afford nickel hydroxide. The concentration of ammonia (or other Lewis bases) and the pH of solution are used to control the crystalline nickel hydroxide product morphology. This enables materials of defined particle size and morphology to be produced. The precipitated, crystalline nickel hydroxide is then filtered from the reaction mixture to afford the desired product.

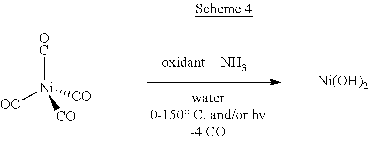

### Example 6

A cathode material precursor is prepared. In a batch, semi-batch or continuous pressure reactor, an oxygen-free suspension of Ni(CO)₄ in water is vigorously stirred at about room temperature. Mn₂(CO)₁₀ and Co₂(CO)₈ are then added as solids or as solutions. The resulting mixture is gently heated (e.g. 0-150° C.) and/or exposed to ultraviolet light to drive off carbon monoxide. This is performed in the presence of ammonia or alternative Lewis bases. The pH of the reaction mixture is optionally controlled by varying the concentration of ammonia or other hydroxide sources (e.g. NaOH, LiOH, CaOH₂, MgOH₂). One or more oxidants are gradually introduced into the reactor either as gases (e.g. O₂, N₂O), salts (e.g. NH₄NO₃) or solutions. Under these conditions, the metal carbonyl complexes react to afford an aqueous solution of metal ions. Controlled precipitation then allows battery precursor products to be obtained, which can then be reacted with a lithium material to form a lithium nickel-manganese-cobalt oxide (NMC).

### Example 7

A cathode material precursor is prepared. In a batch, semi-batch or continuous pressure reactor, an oxygen-free suspension of nickel tetracarbonyl (Ni(CO)₄) in water is gently heated (e.g. 0-150° C.) and/or exposed to ultraviolet light. This is performed in the presence of aqua ammonia or an alternative Lewis base. The pH of the reaction mixture is optionally controlled by varying the concentration of ammonia or other hydroxide sources (e.g. NaOH, LiOH, CaOH₂, MgOH₂). One or more oxidants are gradually introduced into the reactor either as gases (e.g. O₂, N₂O), salts (NH₄NO₃) or solutions.

As the nickel is oxidized to afford Ni²⁺ ions, oxygen-free solutions of manganese sulfate and sodium aluminate are gradually introduced in volume quantities sufficient to achieve the desired cathode stoichiometry. Thereafter, a mixed-metal hydroxide product is precipitated. The concentration of ammonia (or other Lewis bases) and the pH of solution are used to control the crystalline hydroxide product morphology. This enables materials of defined particle size and morphology to be produced. The precipitated, crystalline metal hydroxide is then filtered from the reaction mixture to afford the desired product, which can then be reacted with a lithium material to form a lithium nickel-manganese-aluminum oxide (NMA).

### Example 8

Lithium nickel oxide and/or lithium metal oxides are prepared by vapor-phase deposition of metals onto lithium salt (e.g., Li₂CO₃ or LiOH·H₂O) particles followed by calcination as shown in Scheme 5.

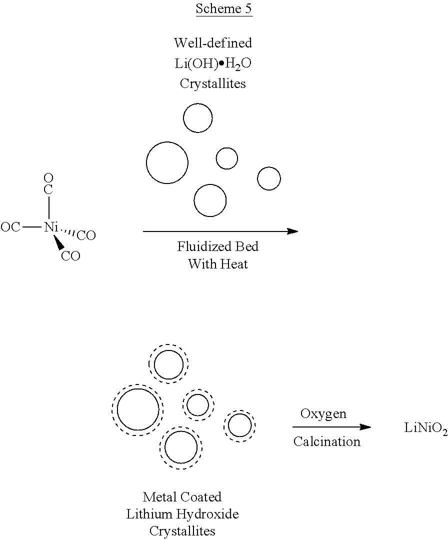

A stream of metal carbonyl vapor or mixed metal carbonyl vapor contained in a carrier gas (e.g., N₂ and/or Ar) is supplied to an agitated, heated pressure vessel containing a lithium salt (e.g., LiOH·H₂O or Li₂CO₃). The vessel temperature is then raised above 150° C. so as to induce thermolysis of the metal carbonyls and the deposition of metal films onto the lithium salt substrate. Residence time and temperature are used to moderate metal film deposition rate and film thickness. As such, metal carbonyls or metal carbonyl mixtures are reacted in the presence of lithium salt (e.g., Li₂CO₃ or LiOH·H₂O) particles to afford metal coated lithium salt (e.g., lithium hydroxide) particles. In some embodiments, with the aid of a carrier gas and/or additives, the particle size and morphology of lithium salt (e.g., Li₂CO₃ or LiOH·H₂O) may function to template metal carbonyl decomposition, and allows products of well-defined size and morphology to be obtained.

The metal coated lithium salts are then transferred to a calcination furnace (600-900° C.) where they are allowed to react to for cathode active materials.

### Example 9

High value salts are prepared by controlled oxidation of Fe(CO)₅ or other metal carbonyls in the presence of acid. An aqueous dispersion of Fe(CO)₅ is gradually heated (e.g. 30-150° C.) in the absence of oxygen whereupon a dilute mineral acid is introduced along with optional additives that may function as oxidants or stabilizers. These additives may include, Lewis bases, surfactants, chelates and oxygen atom transfer reagents (e.g. oxidants). Without being bound by theory, the role of these reagents is to facilitate decarbonylation and controlled oxidation so as to produce ferric or ferrous salts of the mineral acid conjugate bases.

### Example 10

Two vapor streams are co-fed into the top of a vertical, heated tube equipped with a powder collection trap at the bottom. One stream contains iron pentacarbonyl in an inert carrier gas (e.g., Ar or N₂) the other gas stream contains nitrogen and oxygen (<5 v/v %). The vertical tower is heated so as to induce thermolysis of the iron carbonyl. As the iron carbonyl thermolyzes it is allowed to react with oxygen to form high purity iron oxides suitable for use as precursors in the manufacture of lithium iron phosphate.

While certain embodiments have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

The headings provided herein, if any, are for convenience only and do not necessarily affect the scope or meaning of the devices and methods disclosed herein.

What is claimed is:

1. A method of producing a cathode material precursor, comprising:
reacting a metal carbonyl complex with an acid to form a cathode material precursor.

2. The method of claim 1, wherein the metal carbonyl complex comprises a metal selected from the group consisting of Ni, Co, Fe, Mn, and combinations thereof.

3. The method of any one of claims 1-2, wherein the metal carbonyl complex is selected from the group consisting of Ni(CO)₄, Co(CO)₃(NO), H₂Fe(CO)₄, HCo(CO)₄, Co₂(CO)₈, Fe(CO)₅, Mn₂(CO)₁₀, Li[HFe(CO)₄], a metal carbonyl isocyanide complex thereof, a metal carbonyl phosphine complex thereof, and combinations thereof.

4. The method of any one of claims 1-3, wherein the acid is selected from the group consisting of H₃PO₄, H₃PO₃, H₂SO₄, H₂SO₃, HNO₃, HNO₂, HI, HBr, HCl, HF, and combinations thereof.

5. The method of any one of claims 1-4, wherein the metal carbonyl complex is heated to about 30 to 150° C.

6. The method of any one of claims 1-5, further comprising isolating the cathode material precursor.

7. The method of any one of claims 1-6, further comprising reacting the cathode material precursor with a lithium salt compound to form a cathode active material.

8. The method of claim 7, wherein the lithium salt compound comprises at least one of LiOH and LiCO₃.

9. The method of any one of claims 1-8, wherein an iron ore comprises the metal carbonyl complex.

10. The method of claim 9, wherein the iron ore is reacted with the acid to form the cathode material precursor.

11. The method of any one of claims 1-10, wherein the cathode material precursor is selected from the group consisting of a metal hydroxide, a metal oxide, a metal nitrate, a metal sulfate, or a metal phosphate.

12. A method of producing a cathode material precursor, comprising:
heating a metal carbonyl complex to form a metal powder; and
reacting the metal powder with an acid to form a cathode material precursor.

13. The method of claim 12, wherein the metal carbonyl complex is heated at a temperature between 25-200° C.

14. The method of any one of claims 12-13, wherein reacting a metal carbonyl complex with an acid decomposes the metal carbonyl complex into fine particle sized metal powders.

15. The method of claim 14, wherein the fine particle sized metal powders are nano-sized.

16. The method of claim 14, wherein the fine particle sized metal powders range from about 0.1 μm to about 50 μm.

17. The method of any one of claims 12-16, wherein one or more steps are performed in a gaseous phase.

18. A method of producing a cathode active material, comprising:
reacting a metal carbonyl complex with lithium hydroxide to form a lithium hydride metal carbonyl; and
reacting the lithium hydride metal carbonyl with an acid to form a cathode active material.

19. The method of claim 18, further comprising calcinating the lithium metal hydride in the presence of an oxidant.

20. A method of producing a cathode active material, comprising:
reacting a first metal carbonyl complex with a base to form a metal hydroxide.

21. The method of claim 20, further comprising reacting the first metal carbonyl complex with a second metal carbonyl complex, wherein the second metal carbonyl complex is selected from the group consisting of Ni(CO)₄, Co(CO)₃(NO), H₂Fe(CO)₄, HCo(CO)₄, Co₂(CO)₈, Fe(CO)₅, Mn₂(CO)₁₀, Li[HFe(CO)₄], a metal carbonyl isocyanide complex thereof, a metal carbonyl phosphine complex thereof, and combinations thereof.

22. The method of any one of claims 20-21, wherein the first metal carbonyl complex is exposed to ultraviolet light.

23. The method of any one of claims 20-22, wherein the first metal carbonyl complex is exposed to manganese sulfate, sodium aluminate, or combinations thereof.

24. A method of producing a cathode material precursor, comprising:
mixing a first gaseous stream comprising an inert carrier gas and a metal carbonyl complex with a second gaseous stream comprising an oxidant; and
heating the mixed first and second gaseous streams to form a cathode material precursor.
